(19) United States
(12) Patent Application Publication
(10) Pub. No.: US 2015/0017595 A1
(43) Pub. Date: Jan. 15, 2015

(54) Orthodontic Tool for Opening a Self-ligating Bracket

(71) Applicants: Rolf Förster, Pforzheim (DE); Carsten Wagner, Bretten (DE)

(72) Inventors: Rolf Förster, Pforzheim (DE); Carsten Wagner, Bretten (DE)

(73) Assignee: Bernhard Förster GmbH, Pforzheim (DE)

(21) Appl. No.: 14/329,728

(22) Filed: Jul. 11, 2014

(30) Foreign Application Priority Data
Jul. 12, 2013 (DE) 10 2013 107 401.4

(51) Int. Cl. A61C 7/02; A61C 7/28

(52) U.S. Cl. CPC A61C 7/02; A61C 7/287
USPC 433/3

(57) ABSTRACT

The invention relates to an orthodontic tool for opening a self-ligating bracket, having a body (10) which carries on its end a tappet (12) for displacing a clamp (5) of the bracket out of its closed position and into its open position, an annular groove (13) being situated between the tappet and the body, in which an upper edge of the bracket engages in displacement of the clamp (5) out of its closed position and into its open position between the tappet (12) and the body (10) for axial positioning of tappet (12) with respect to the bracket to be opened. The invention also relates to a system having such a tool and a self-ligating bracket.

The invention relates to a tool for opening a self-ligating bracket.

Self-ligating brackets usually have a clamp that is situated with a channel running beneath the slot in its lower leg and covering the slot with its upper leg in the closed position. Such brackets are described in DE 10 2005 056 184 A1, for example. To open such a bracket, the clamp must be shifted out of the closed position and into the open position. To do so, a tool can be inserted into an opening in the upper leg or the end of the lower leg protruding out of the channel may be pushed into the channel. Such a tool is often referred to as a probe.

An object of the present invention is to show a method for making it easier for orthodontic practioners to open self-ligating brackets.

This object is achieved by a tool having the features defined in claim 1. Advantageous refinements of the invention are the subject matter of the dependent claims.

A tool according to the invention has a tappet, which is used to open the bracket on the lower leg of a clamp, namely by the tappet pressing against a free end of the lower leg and thereby shifting the clamp across the direction of the slot. An annular groove, which permits easy axial positioning of the tappet, is situated between this tappet and the body of the tool. To open a bracket, the tool is placed on the upper edge between the two wings of the bracket, so that the upper edge of the bracket engages in the annular groove. For displacement of the clamp into its open position, the tool is then pivoted about this upper edge of the bracket. The distance from the distal end of the tappet to the annular groove is such that the tappet necessarily abuts against the lower leg of the clamp and displaces it in this pivoting operation.

Therefore, when a tool is being used according to the invention, it is not necessary to see the end of the lower leg of the clamp of a bracket to be displaced in order to be able to open the bracket. It is sufficient to guide the tool between the two wings of the bracket and to place it on the upper edge of the bracket with the annular groove. A simple pivoting movement of the tool is then sufficient to open it. With a tool according to the invention, the time required by an orthodontic surgeon to open a self-ligating bracket can therefore be reduced significantly.

An advantageous refinement of the invention provides that the annular groove is situated in a peg, which is connected to the body at one end and to the tappet at the other end. The width of this peg is greater than the width of the tappet. In the case of a rotationally symmetrical tappet or peg, the width corresponds to the maximum diameter. However, the tappet and the peg need not necessarily be designed with rotational symmetry. The greater width of the peg results in a radial positioning of the tool, so it defines the section of the upper edge of the bracket that engages in the annular groove. Since the peg is of such dimensions that it fits between the two wings, the radial positioning of the tool is thus also predetermined mechanically. The width of the peg thus ideally corresponds to the distance between the two wings of the bracket to be opened. The more the distance between the two wings exceeds the width of the peg, the more the tool can move along the edge when it is attached to the upper edge of the bracket and thus the less its radial position is predetermined.

In a region adjacent to the annular groove, the body preferably has a width greater than the width of the peg. It is particularly advantageous if the width of the body in a region adjacent to the annular groove is greater than the distance between the two wings of the bracket to be opened. This further facilitates the correct placement of the tool on the bracket.

The peg preferably forms an annular shoulder facing the tappet. To close a bracket, the tappet can be inserted into an opening in the upper leg of the clamp. The annular shoulder then forms an advantageous stop when the tappet is inserted into the opening in the clamp. A tool according to the invention can therefore also be used very well for closing a self-ligating bracket in this way.

Another advantageous refinement of the invention provides that the body of the tool forms an annular shoulder adjacent to the groove. The annular shoulder forms an advantageous contact surface on the upper edge of the bracket and facilitates the pivoting movement for opening the bracket.

Another advantageous refinement of the invention provides that the annular groove has an arc-shaped cross-sectional profile. This advantageously facilitates the pivoting of the tool about the upper edge of the bracket.

Another advantageous refinement of the invention provides that the peg and tappet are designed with rotational symmetry. The peg and the tappet are preferably concentric, i.e., have rotational symmetry with respect to the same geometric axis of rotation. A section of the body adjacent to the annular groove is preferably also designed with rotational symmetry, for example, being designed to be cylindrical. This section of the body is preferably concentric with the peg and the tappet.

A tool according to the invention together with a self-ligating bracket forms a system. The bracket of such a system has a base for being cemented onto a tooth, a socket disposed on the base, having at least two wings and a slot for accommodating a curved wire. The base has a channel running between the two wings beneath the slot, a lower leg of a clamp whose upper leg closes the slot in its closed position sitting in the slot.

The tool and the bracket are coordinated, so that when the tool is pivoted around the upper edge of the bracket when the upper edge is engaging in the annular groove, the tappet causes a shift in the free end of the lower leg of the clamp, which protrudes out of the channel, in the direction of the channel.

Additional details and advantages of the invention are explained based on one exemplary embodiment with reference to the accompanying drawings, in which:

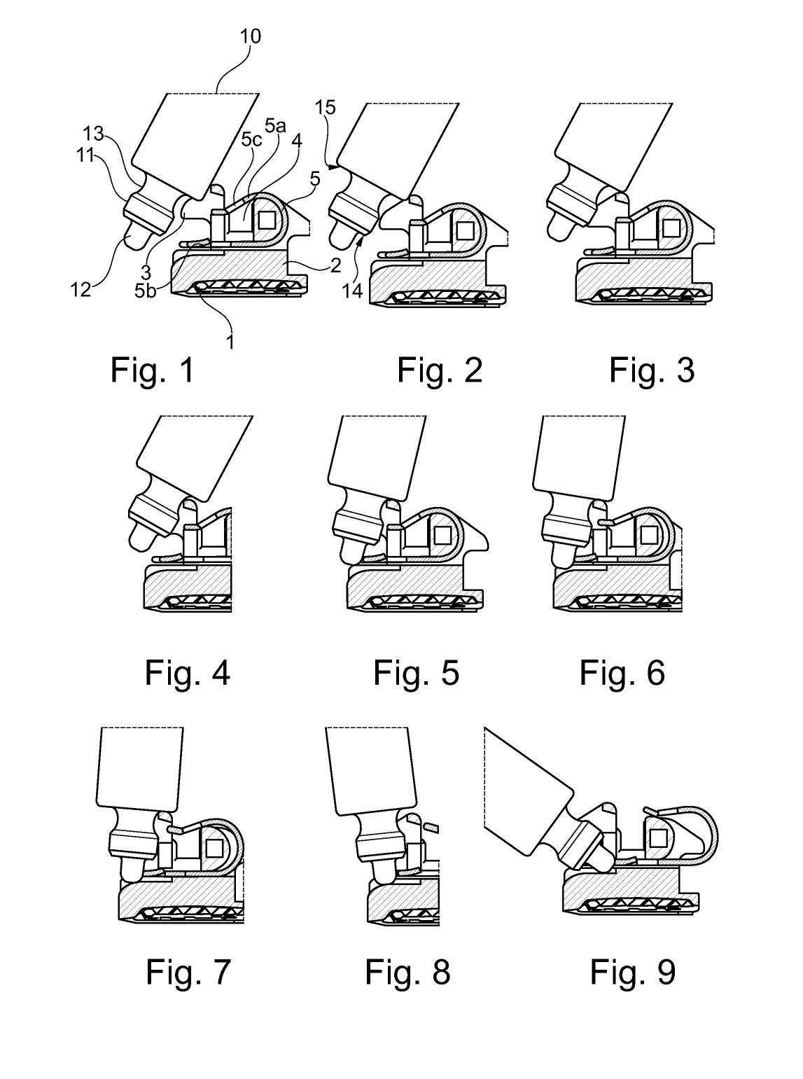

FIG. 1 shows a detailed view of a tool and a sectional view of a self-ligating bracket; and

FIGS. 2 to 9 show a sequence of positions of the tool in opening the bracket.

FIGS. 1 to 9 show schematically one example of a possible sequence of movements for opening a self-ligating bracket. The bracket is shown in a sectional view in FIGS. 1 to 9. Only the front part of the tool, which interacts with the bracket in opening it, is shown of the tool used for opening the bracket. Like conventional probes for orthodontic surgeons, the tool has an elongated body, which permits easy gripping of the tool.

The bracket has a base for cementing to a tooth, a socket 2 disposed on the base 1, which has two ligature wings 3 and a slot 4 for receiving a wire. The sectional plane of FIGS. 1 to 9 runs perpendicular to the slot 4, so that only one of the two ligature wings 3 can be seen here. The slot 4 is closed by a clamp 5. In the closed position of the clamp 5 shown in FIG. 1, an upper leg 5a of the clamp 5 covers the slot 4. A lower leg 5b of the clamp 5 sits in a channel, which runs in the socket 2 beneath the slot 4. The lower leg 5b protrudes at its free end out of the channel and is connected at its other end to the upper leg 5a.

The tool has a body 10 which carries a peg 11 with a tappet 12 at one end. The body 10, the peg 11 and the tappet 12 are preferably designed to be rotationally symmetrical about the same geometric axis of rotation. The peg 11 has an annular groove 13. To open the bracket, this annular groove 13 is placed on an upper edge of the bracket between the two wings 3.

In FIG. 1, the body 10 of the tool is in contact with the upper edge of the bracket between the two wings 3. To open the bracket, the body 10 is therefore pulled upward until the upper edge of the bracket engages in the annular groove 13. This position of the tool is illustrated in FIG. 4.

When the upper edge of the bracket engages in the annular groove 13, the tool is pivoted about the upper edge. The tappet 12 is moved toward the lower leg 5b of the clamp 5 and then shifts the lower end of the clamp 5 to the channel, so that the clamp 5 is moved out of its closed position and into its open position. The annular groove 13 thus produces an axial positioning of the tool with respect to the bracket. The tool and the bracket are designed and coordinated with one another, so that when the tool is pivoted about the upper edge of the bracket when the upper edge lies in the annular groove 13, the tappet 12 strikes the lower leg 5b of the clamp 5 and then shifts it. The clamp 5 is then shifted perpendicular to the direction of the slot 4. The free end of the lower leg 5b of the clamp 5 protruding out of the channel such that the tappet 12 strikes this lower leg in the pivoting movement, is then shifted toward the slot 4.

The annular groove 13 preferably has an arc-shaped cross section to facilitate the pivoting process. The maximum diameter of the peg 11 is designed to fit the distance between the two ligature wings 3. The peg 11 of the bracket thus causes a radial positioning of the tool with respect to the bracket. The tappet 12 is thinner than the peg 11. For operating the clamp 5, the tappet 12 may therefore also be inserted into an opening 5c in the upper leg 5a of the clamp 5. An annular shoulder 14 forming the peg 11 on its end facing the tappet 12 acts as a stop here.

The body 10 of the tool is wider than the peg 11. The body 10 is preferably wider than the distance between the two ligature wings 3 of the bracket, which facilitates the positioning of the tool on the bracket. The body 10 may form an annular shoulder 15 on its end facing the peg 11 in order to form a contact surface, which is advantageously large and on which the upper edge of the bracket comes to rest in the pivoting movement.

The tappet 12 may have a cylindrical section and is rounded, preferably with a camber on its distal ends. In this way, the tappet 12 can advantageously slide on the socket 2 in the pivoting movement of the tool. Tilting of the tool is prevented by the cambered rounding of the tappet 12.

The peg 11 may have a cylindrical section between the annular groove 13 and the tappet 12, as illustrated in the figures. The annular shoulder 14 of the peg 11 is preferably adjacent to a tapering section of the peg 11. In this way, the peg 11 can advantageously slide along the side wall bordering the slot 4 in the pivoting movement, its upper edge engaging in the annular groove 13 of the tool.

### LIST OF REFERENCE NUMERALS

1. base

2. socket

3. ligature wings

4. slot

5. clamp

5a. upper leg

5b. lower leg

10. body

11. peg

12. tappet

13. annular groove

14. annular shoulder

15. annular shoulder

1. An orthodontic tool for opening a self-ligating bracket, said tool comprising a body having an end with a tappet configured for displacing a clamp of the bracket out of its closed position and into its open position,
said tool also comprising an annular groove configured for engaging an upper edge of the bracket during displacement of the clamp out of its closed position and into its open position, said annular groove being arranged is between the tappet and the body and being configured for axial positioning of the tappet with respect to the bracket to be opened.

2. The orthodontic tool according to claim 1, wherein the annular groove is in a peg which is disposed between the body and the tappet and has a width greater than the width of the tappet.

3. The orthodontic tool according to claim 2, wherein the body has a width greater than the width of the peg in the region adjacent to the annular groove.

4. The orthodontic tool according to claim 3, wherein the body has an annular shoulder adjacent to the annular groove.

5. The orthodontic tool according to claim 2, wherein the peg has a cylindrical section.

6. The orthodontic tool according to claim 2, wherein the peg forms an annular shoulder facing the tappet.

7. The orthodontic tool according to claim 6, wherein the peg has a section which is adjacent to the annular shoulder of the peg and tapers toward this annular shoulder.

8. The orthodontic tool according to claim 1, wherein the tappet has a rounded end with a camber.

9. The orthodontic tool according to claim 1, wherein the annular groove has a curved cross section.

10. A system comprising an orthodontic tool according to claim 1 and a self-ligating bracket, said bracket having a base for cementing onto a tooth, a socket disposed on the base and having at least two wings and a slot to receive a wire, wherein the socket has a channel running between the two wings beneath the slot, in which one leg of a clamp whose other leg covers the slot in its closed position, is located.

11. The system according to claim 10, wherein the body of the tool has a width greater than the distance between the two wings of the bracket in a region adjacent to the annular groove.

12. The system according to claim 10 and claim 2, wherein the peg has a width that fits the distance between the two wings for radial positioning between the two wings of the bracket.
